(19) United States
(12) Patent Application Publication
(10) Pub. No.: US 2024/0148191 A1
(43) Pub. Date: May 9, 2024

(54) Cook Caddy

(71) Applicant: Bill Elliott Owenby, Marana, AZ (US)

(72) Inventor: Bill Elliott Owenby, Marana, AZ (US)

(73) Assignee: Bill Elliott Owenby, Marana, AZ (US)

(21) Appl. No.: 17/981,160

(22) Filed: Nov. 4, 2022

(51) Int. Cl. A47J 43/28

(52) U.S. Cl. CPC A47J 43/28

(57) ABSTRACT

A silicone ergonomic cylinder is placed in the middle of food or cookware to create additional surface area, thus increasing the cooking of food evenly due to heat being dispersed effectively and consistently. Since there are no other products out there, this simple handheld device will aid any cook's duties to provide efficient and evenly cooked meals by reducing costs, improving heat conduction through the increased surface area by physically placing the heat-resistant object in the middle.

### CROSS REFERENCES

Attached in Another File

No Joint Research Agreement or Federally Sponsored Research or Development

No Prior Disclosures or Joint Inventor

### BACKGROUND OF THE INVENTION

### Field of the Invention

This item is classified within Kitchen/Kitchen Utensils/Cookware/Cooking.

Problem Solved: When cooking food, whether in the stove or in the microwave, food can become uncooked unevenly in the center of meals. This is due to heating issues which undercooks the middle and overcooking the outside, sides, and top. As a result of undercooking, this leads to food safety risks, quality of food outcomes, and frustration by the cook. If left uncooked in the center, it poses the risk of food-borne and undercooked diseases and health-related issues.

Comparison to Other Products: There are no other products out there besides sticking a toothpick in the middle to seeing if the brownies are still gooey or cakey, so it is hard to compare or critique. Most other products require you to stop cooking to stir and or handle hot cookware, while this remains in thus reducing time, energy, and safety concerns. Microwaves operate on the notion of changing/heating water molecules in order to expand heat, but if solid food/concentrated areas in the middle of food are dense or frozen, heating of the food's middle is the challenge while overcooking/overdrying the top and outside of reheated foods.

Since there are no other products out there, this simple handheld device will aid any cook's duties to provide efficient and evenly cooked meals by reducing costs, improving heat conduction through the increased surface area by physically placing the heat-resistant object in the middle.

### SUMMARY OF THE INVENTION

When cooking food, particularly in the microwave, food can become uncooked if not evenly in the center of meals, causing heating issues, undercooking of the middle, and overcooking the outside and top, which leads to food safety risks, quality of food outcomes, and frustration by the cook. If left uncooked in the center, it poses the risk of food-borne and undercooked diseases and health-related issues. The invention claimed here solves this problem.

This silicone cylinder when placed in the middle of food bowls, pots, or pans, will physically create more surface area in the middle of the food, therefore, cooking food faster and more evenly thus improving quality, safety, and reducing utility service costs.

The claimed invention differs from what currently exists. There are no other products out there that perform this task, based on Google Patent Search online, Legal Zoom formal assistance, as well as US.GOV patent searches independently.

This invention is an improvement on what currently exists. There are no other products out there that perform this task, based on Google Patent Search online, Legal Zoom formal assistance, as well as US.GOV patent searches independently.

Most other products require you to stop cooking to stir and or handle hot cookware, while this remains in thus reducing time, energy, and safety concerns. Microwaves operate on the notion of changing/heating water molecules in order to expand heat, but if solid food/concentrated areas in the middle of food are dense, heating of the food's middle is the challenge while overcooking/overdrying the top and outside of reheated foods.

Since there are no other products out there, this simple handheld device will aid any cook's duties to provide efficient and evenly cooked meals by reducing costs, improving heat conduction through the increased surface area by physically placing the heat-resistant object in the middle.

### DESCRIPTION OF THE INVENTION DRAWINGS

FIG. 1: A Drawing of the Cook Caddy invention—

The ergonomic shape of the silicone material Cook Caddy will have a flat base on the bottom so it can stand independently of whatever food item placed; the self-standing nature of the flat base will work in soups, pasta, or layered dishes all the same.

The shaft of the Cook Caddy will be curved slightly to allow maximum heat dissipation and increase the amount of area for food to continue to heat/cook/expand.

The top will have a specific option to pinch/grab the Cook Caddy from hot food without heat-related injuries.

FIG. 1 shows a tab for pinching to pick up.

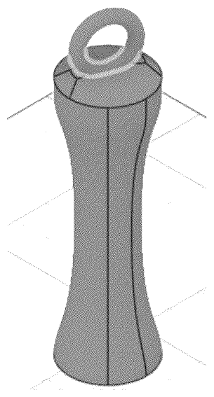

### DETAILED DESCRIPTION OF THE INVENTION

As stated above, when cooking food, particularly in the microwave, food can become uncooked if not evenly in the center of meals, causing heating issues, undercooking of the middle, and overcooking the outside and top, which leads to food safety risks, quality of food outcomes, and frustration by the cook. If left uncooked in the center, it poses the risk of food-borne and undercooked diseases and health-related issues. The invention claimed here solves this problem.

This silicone cylinder when placed in the middle of food bowls, pots, or pans, will physically create more surface area in the middle of the food, therefore, cooking food faster and more evenly thus improving quality, safety, and reducing utility service costs.

The claimed invention differs from what currently exists. There are no other products out there that perform this task, based on my online, Legal Zoom formal assistance, as well as US.GOV patent searches.

This invention is an improvement on what currently exists. There are no other products out there that perform this task, based on my online, Legal Zoom formal assistance, as well as US.GOV patent searches.

Most other products require you to stop cooking to stir and or handle hot cookware, while this remains in thus reducing time, energy, and safety concerns. Microwaves operate on the notion of changing/heating water molecules in order to expand heat, but if solid food/concentrated areas in the middle of food are dense, heating of the food's middle is the challenge while overcooking/overdrying the top and outside of reheated foods.

Since there are no other products out there, this simple handheld device will aid any cook's duties to provide efficient and evenly cooked meals by reducing costs, improving heat conduction through the increased surface area by physically placing the heat-resistant object in the middle.

The Version of The Invention Discussed Here Includes:
1. Obtain food-grade, heat-resistant, and leak-resistant silicone for food safety, cooking capabilities, and health-oriented options in the kitchen.
2. Once you've obtained the food-grade silicone base for molding, mold the silicone object into the appropriate size and shape based mold per the design (see illustrations).
3. Once molded into the ergonomic and hand-held user friendly design, test for quality and durability assurance.
4. Once quality is assured, possibly consider applying food-grade coating to avoid outside food staining or dishwashing chemicals and food/silicone leakage if needed/recommended.
5. Prepare the product for packaging and shipping.

### Relationship Between the Components:

The invention will be one complete ergonomic design made within another food-grade silicone mold for safety, food quality, and durability.

### How the Invention Works:

The person uses this invention by placing it in the middle of their food (fresh or reheated leftovers). Once in the middle, the food-grade, heat-resistant silicone invention creates an additional surface area within the center of the food, therefore, improving heat absorption and expansion in the center of the meal, thus solving the ongoing problem of ‘it's still cold in the middle!’ and having to overcook the food in the microwave. Same utilization for stovetop and in-stove meals.

### How to Make the Invention:

Once a person obtains the necessary food-grade and heat-resistant silicone, the liquid silicone would be poured into the food-grade molding, wait for the necessary timeframe for solidification, and remove to smoothen out mold lines (if needed), tested for quality and durability, and possibly consider adding food-grade safety coating to reduce transference of food, dish soap (when cleaning) and or staining.

Food grade silicone is a necessity for health and safety purposes, heat-resistance quality up to 425 degrees F. (possibly 450 degrees F. if the material is found) to protect against melting and or touching with hands, and a coating treatment may be indicated to prevent leakage or staining from food/cooking.

### How to Use the Invention:

The person uses this invention in the microwave by placing it in the middle of their leftovers or freshly cook/cooking food. Once in the middle of the food (whether on a plate, bowl, or cookware), the food-grade heat-resistant silicone invention creates an additional surface area within the center of the food, therefore, improving heat absorption and expansion in the center of the meal, thus solving the ongoing problem of ‘it's still cold in the middle!’ and having to overcook the food in the microwave. Same utilization for stovetop and in-stove meals.

1. A cylinder apparatus comprising:
essentially of silicone material able to withstand temperatures upwards of 450 degrees Fahrenheit in a rod handle shape
